(19) United States
(12) Patent Application Publication
(10) Pub. No.: US 2024/0288398 A1
(43) Pub. Date: Aug. 29, 2024

(54) BIOSENSOR TO DETECT CANCER PRECURSORS

(71) Applicant: Board of Regents, The University of Texas System, Austin, TX (US)

(72) Inventors: Md Nurunnabi, El Paso, TX (US); Md Ariful Ahsan, El Paso, TX (US); Jaqueline Pena-Zacarias, Socorro, TX (US)

(21) Appl. No.: 18/443,601

(22) Filed: Feb. 16, 2024

Related U.S. Application Data
(60) Provisional application No. 63/486,876, filed on Feb. 24, 2023.

(51) Int. Cl. G01N 27/327; G01N 27/36

(52) U.S. Cl. CPC G01N 27/3278; G01N 27/36; G01N 2333/205

(57) ABSTRACT

An apparatus for detecting cancer precursors in a sample by using electrodes modified with a nanocomposite that reacts with a number of cancer precursors. The modification of electrodes includes treating surfaces of the electrodes using the nanocomposite, wherein the nanocomposite includes a first metallic nanoparticle; and at least one of a second metallic nanoparticle, or carbon nanomaterial. The apparatus also includes an analytic tool for quantifying detected cancer precursors, and a display to visualize amounts of cancer precursors detected in the sample.

### CROSS-REFERENCE TO RELATED APPLICATION

Referring to the application data sheet filed herewith, this application claims a benefit of priority under 35 U.S.C. 119(e) from co-pending provisional patent application U.S. Ser. No. 63/486,876, filed Feb. 24, 2023, the entire contents of which are hereby expressly incorporated herein by reference for all purposes.

### BACKGROUND

### 1. Field

The disclosure relates generally to a biosensor and more specifically to a biosensor for an electrochemical immunosensing platform for early diagnosis of gastric cancer by measuring concentration for cancer precursors in samples.

### 2. Background

Gastric cancer is the fourth leading type of cancer that patients are commonly diagnosed with worldwide. Gastric cancer can be classified into one of two groups that differ in frequency and cause, specifically, a group which arises from the upper region of the stomach and the other group which arises from other regions of the stomach.

It is known that food preservatives such as sodium nitrates are responsible for the creation of N-nitroso compounds, which exhibit high carcinogenic properties. The N-nitroso compounds' carcinogenic property is a result of N-nitroso compounds being mutagenic and teratogenic. For example, in order to carry out their metabolic process, the N-nitroso compounds undergo reactive intermediate formation of a methyl-Carbonium ion that interacts with a variety of cellular macromolecules to cause mutation of healthy cells.

Currently, several screening techniques are used to diagnose gastric cancer. These techniques include barium-meal photofluorography, gastric endoscopy, and serum pepsinogen. However, around 62% of individuals diagnosed with gastric cancer already have cancer spread throughout the rest of their bodies by the time of the diagnosis in the United States.

### SUMMARY

An illustrative embodiment of the present disclosure provides an apparatus for detecting a cancer precursor, comprising: a number of electrodes modified with a nanocomposite, wherein the nanocomposite reacts with a number of cancer precursors.

An illustrative embodiment of the present disclosure provides a biosensor device for detecting cancer precursors in a sample, comprising: a number of electrodes modified with a nanocomposite, wherein the nanocomposite reacts with a number of cancer precursors in the sample; an analytic tool configured to quantify the number of cancer precursors reacted with the nanocomposite; and a display to visualize amounts of the number of cancer precursors in the sample.

Another illustrative embodiment of the present disclosure is a method of detecting cancer precursors, comprising: reacting a nanocomposite located on a number of electrodes with a number of cancer precursors in a sample; and quantifying the number of cancer precursors reacted with the nanocomposite.

Another illustrative embodiment of the present disclosure is a composition of matter for detecting cancer precursors, comprising: an electrode; and a nanocomposite comprising: a first metallic nanoparticle; and at least one of a second metallic nanoparticle, or carbon nanomaterial.

Another illustrative embodiment of the present disclosure is a method of manufacturing a sensor to detect cancer precursors, comprising: treating a surface of a carbon electrode with at least one of a first metallic nanoparticle and a second metallic nanoparticle.

Other objects, features and advantages of the present disclosure will become apparent from the following detailed description. It should be understood, however, that the detailed description and the specific examples, while indicating preferred embodiments of the present disclosure, are given by way of illustration only, since various changes and modifications within the spirit and scope of the present disclosure will become apparent to those skilled in the art from this detailed description.

### BRIEF DESCRIPTION OF THE DRAWINGS

FIG. 1 illustrates a cancer development and detection apparatus in accordance with an with an illustrative embodiment;

FIG. 2 illustrates a schematic diagram of a biosensor device in accordance with an illustrative embodiment;

FIG. 3A illustrates a biosensor device with samples in accordance with an illustrative embodiment;

FIG. 3B illustrates a comparison between unmodified electrodes and modified electrodes in accordance with an illustrative embodiment;

FIG. 4A illustrates exemplary chemical structures and origins of cancer precursors such as nitroso compounds that can be detected from samples in accordance with an illustrative embodiment;

FIG. 4B illustrates a chemical reaction between electrodes and cancer precursors in accordance with an illustrative embodiment;

FIG. 5 illustrates a graphical representation of an alternative embodiment for a biosensor device in accordance with an illustrative embodiment;

FIG. 6 illustrates an electrochemical characteristic of a copper cobalt modified glassy carbon electrode and a screen printed carbon electrode in accordance with an illustrative embodiment;

FIG. 7 illustrates electrochemical analysis of the modified electrodes with three CuCo/C nanocomposites ratios in accordance with an illustrative embodiment;

FIG. 8 illustrates electrochemical analysis for the modified electrodes with three CuCo/C nanocomposites ratios in accordance with an illustrative embodiment;

FIG. 9 illustrates electrochemical analysis for the modified electrodes with CuCo(1:1)/C nanocomposites ratios in accordance with an illustrative embodiment;

FIGS. 10-11 illustrate an evaluation of modified electrodes using differential pulse voltammetry (DPV) plot and calibration plot of electrodes modified with Cu:Co(1:1)/C nanocomposite for nitrosodipropylamine(NDPA) sensing in accordance with an illustrative embodiment;

FIGS. 12-12B illustrate an evaluation of modified electrodes using DPV plot to results of electrodes modified with Cu:Co(1:1)/C nanocomposite for NDPA sensing in real samples from patients in accordance with an illustrative embodiment;

FIG. 13 illustrates a flowchart of a process for detecting cancer precursors in accordance with an illustrative embodiment; and

FIG. 14 illustrates a flowchart of a process for manufacturing a sensor to detect cancer precursors in accordance with an illustrative embodiment.

### DETAILED DESCRIPTION

The illustrative embodiments recognize and take into account a number of different considerations as described herein. For example, the illustrative embodiments recognize and take into account that two types of gastric cancer differ in frequency and cause. However approximately 90% of gastric cancer diagnoses are classified as adenocarcinomas, meaning that the cancer originates in the tissue lining the stomach, which is also responsible for the production and release of mucus and fluids.

The illustrative embodiments also recognize and take into account that a number of techniques are currently used to diagnose gastric cancer. For example, barium-meal photofluorography, gastric endoscopy, and serum pepsinogen. The illustrative embodiments also recognize and take into account that those techniques demonstrate a very low positive predictive value (PPV), even in patients at high risk.

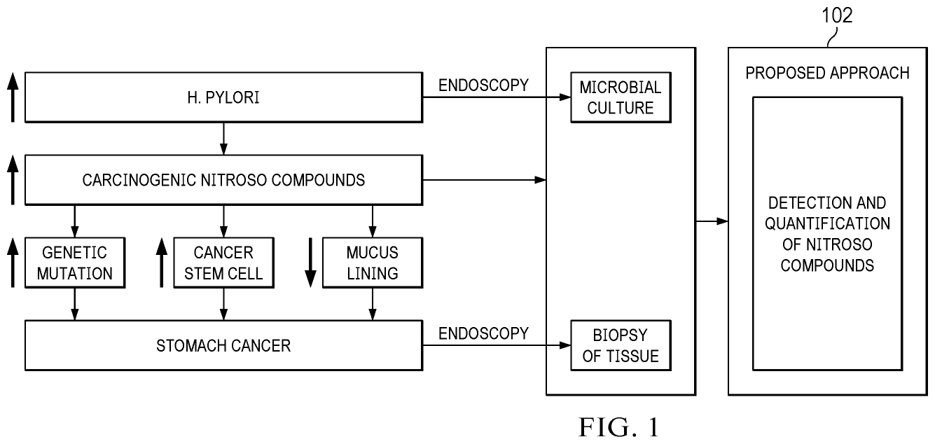

With reference now to the figures, and in particular, with reference to FIG. 1, an illustration of a cancer development and detection apparatus is depicted in accordance with an embodiment of this disclosure.

An increased H. pylori infection in gastric region causes carcinogenic nitroso compounds to develop. As a result, increased quantity of carcinogenic nitroso compounds leads to an increased genetic mutation and cancer stem cell development in the gastric region. In addition, increased quantity of carcinogenic nitroso compounds causes the inner lining of the stomach to become thinner and decreases the amount of gland cells responsible for releasing substances that aid in digestion. Consequently, lesions develop and act as a precursor to gastric cancer. The current diagnostic approach only provides an analysis for a microbial culture of H. pylori and biopsy of cancerous tissue obtained by endoscopy. In this case, a proposed approach 102 that includes detection and quantification of the carcinogenic nitroso compounds can be helpful to early-stage gastric cancer identification because the carcinogenic nitroso compounds act as markers for genetic mutations, cancer stem cell development, and decreased mucus lining.

As used herein, when used with reference to items, “a number of” means one or more of the items. For example, “a number of different types of communication networks” is one or more different types of communication networks. Similarly, “a set of,” when used with reference to items, means one or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

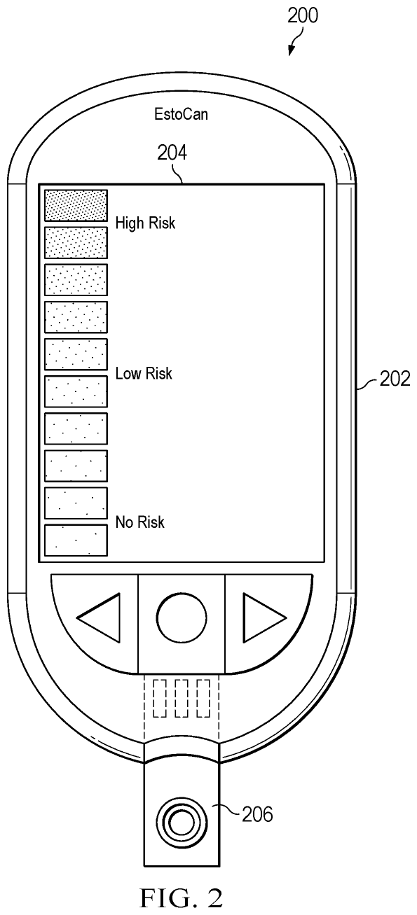

With reference now to FIG. 2, an illustration of a biosensor device is depicted in accordance with an illustrative embodiment. Biosensor device 200 is an example of biosensor used to detect and quantify cancer precursors such as carcinogenic nitroso compounds in FIG. 1, in this illustrative example, biosensor device 200 includes a biosensor 206 to detect cancer precursors in a sample and quantify cancer precursors according to concentration of cancer precursors in the sample. In this example, biosensor 206 performs detection by using electrodes modified with nanocomposite to react with cancer precursors. The electrodes can be glassy carbon electrodes, screen printed carbon electrodes, or any suitable electrodes. Biosensor device 200 further includes display panel 202 that displays information derived from detection and quantification of cancer precursors in the sample. In one illustrative example, display panel 202 can display a colored gradient 204 to present a magnitude of cancer precursors concentration in the sample. In this illustrative example, colored gradient 204 represents a scale of risks for gastric cancer based on detected concentration of cancer precursors in the sample. For example, red marker on colored gradient 204 indicates high risk of cancer because a high concentration of cancer precursors is detected, while a yellow marker on colored gradient 204 indicates low risk of cancer because a low concentration of cancer precursors is detected.

It should be understood that colored gradient 204 is only one embodiment of the present disclosure. Display panel 202 can also be configured to display other types of visualizations for presenting concentrations of detected cancer precursors.

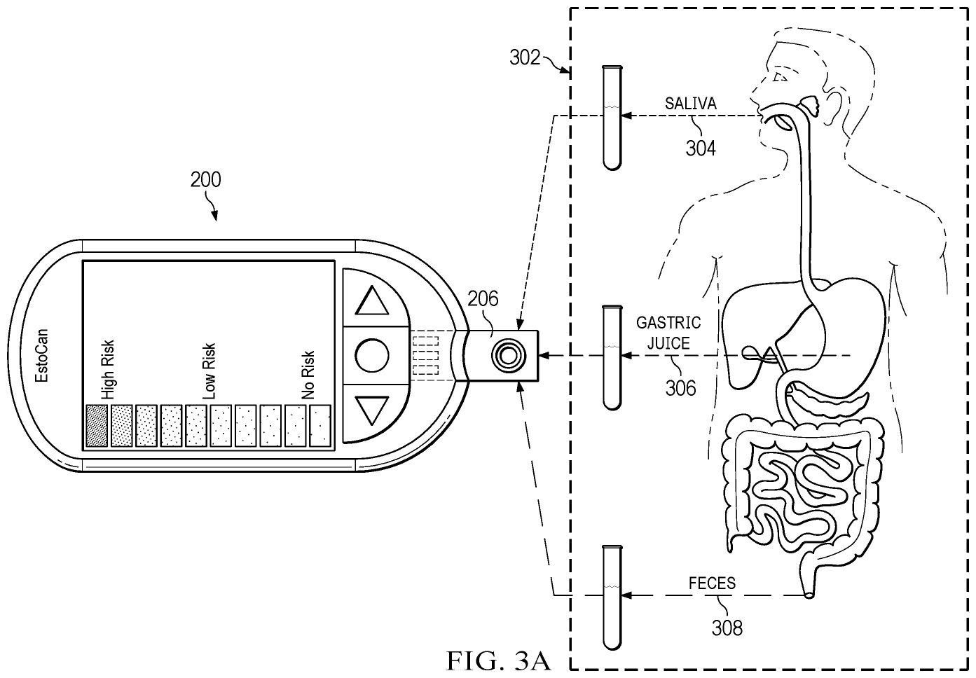

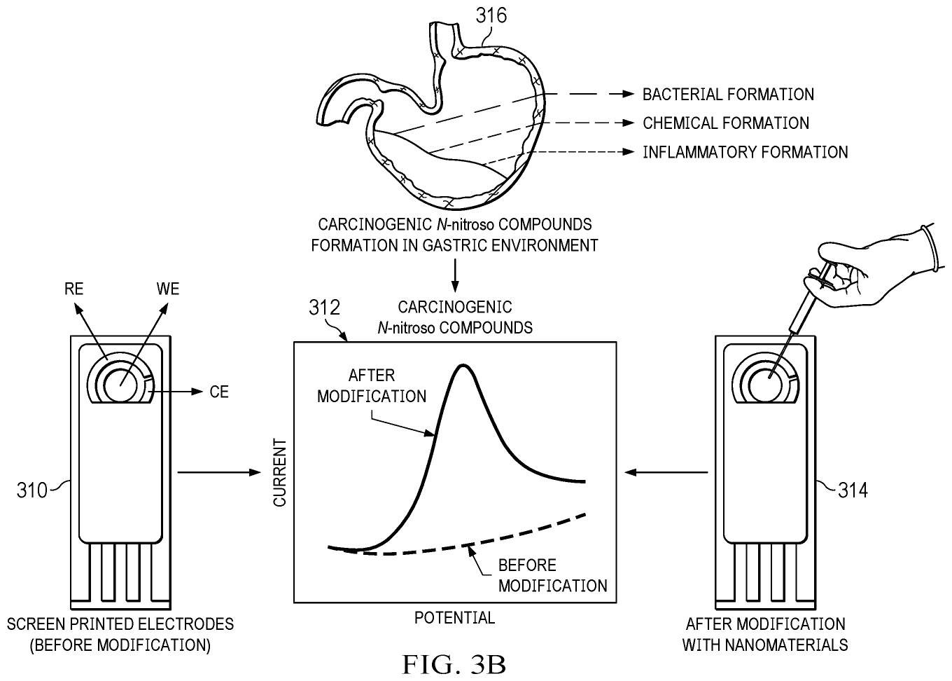

With reference now to FIG. 3A, an illustration of a biosensor device with samples is depicted in accordance with an illustrative embodiment. In the illustrative examples, the same reference numeral may be used in more than one figure. This reuse of a reference numeral in different figures represents the same element in the different figures. As depicted, biosensor 206 in biosensor device 200 detects and quantifies cancer precursors concentration in a sample, such as sample 302. In this illustrative example, sample 302 can be saliva sample 304, a gastric juice sample 306, or a feces sample 308.

With reference now to FIG. 3B, an illustration of a comparison between unmodified electrodes and modified electrodes is depicted in accordance with an illustrative embodiment. In FIG. 3B, carcinogenic nitro compounds formation may result from bacterial formation, chemical formation, and inflammatory formation in a gastric environment. In this illustrative example, sample 316 is retrieved from the gastric environment for analysis. Sample 316 can be an example of gastric juice sample 306 in FIG. 3A.

Sample 316 is added to unmodified biosensor device 310 and modified biosensor device 314. Unmodified biosensor device 310 includes a biosensor component that uses an unmodified screen printed electrode to detect carcinogenic nitroso compounds in sample 316. On the other hand, modified biosensor device 314 includes a biosensor component that uses a modified screen printed electrode to detect carcinogenic nitroso compounds in sample 316. In this example, modified biosensor device 314 can be an example of biosensor device 200 in FIG. 2 and FIG. 3A. The results of detections performed by unmodified biosensor device 310 and modified biosensor device 314 are displayed in plot 312. As depicted in plot 312, modified biosensor device 314 shows a significantly better response to the carcinogenic nitro compounds in sample 316 compared to unmodified biosensor device 310.

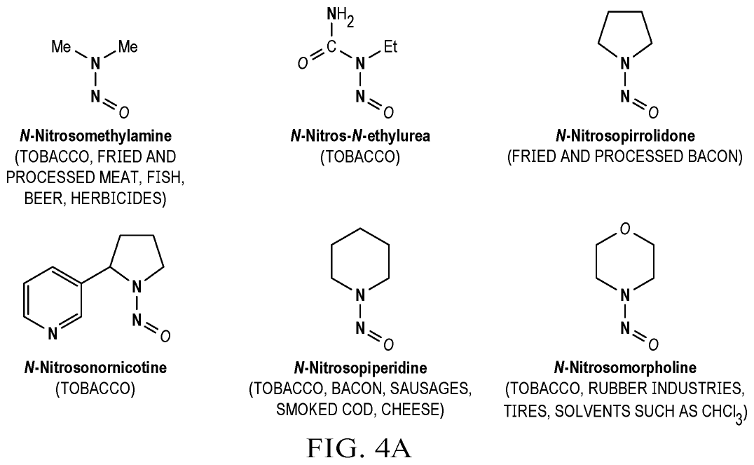

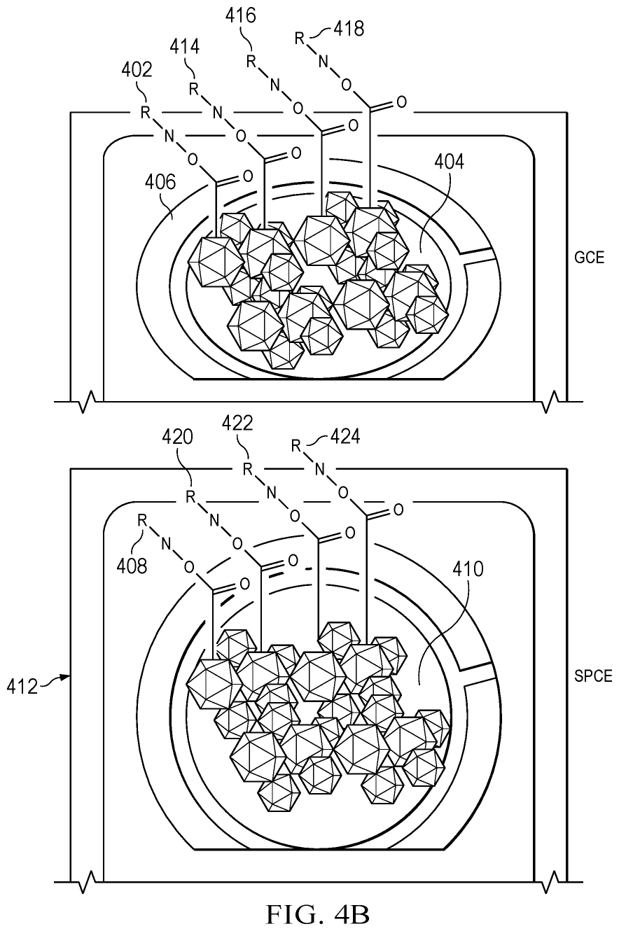

With reference now to FIG. 4A, an exemplary illustration of chemical structures and origins of cancer precursors such as nitroso compounds that can be detected from samples is depicted in accordance with an illustrative embodiment. Examples of nitroso compounds that can be detected include the following.

### List of Nitroso Compounds:

| Nitroso Compounds | Origin |
|---|---|
| N-nitrosomethylamine | Tobacco, fried and processed meat, |
| | fish, beer, herbicides |
| N-nitroso-N-ethylurea | Tobacco |
| N-nitrosopirrolldone | Fried and processed bacon |
| N-nitrosonornicotine | Tobacco |
| N-nitrosopiperidine | Tobacco, bacon, sausages, smoked |
| | cod, cheese |
| N-nitrosomorpholine | Tobacco, rubber industries, tires, |
| | solvents |

It should be understood that list of nitroso compounds are only examples of cancer precursors that can be detected using a device disclosed by instant disclosure. Other nitroso compounds such as N-nitrosodiethylamine and N-nitrosodiethanolamine can also be detected using a device disclosed by instant disclosure. In addition, other cancer precursors such as H. pylori virulence factor can also be detected using a device disclosed by instant disclosure. In this example, H. pylori virulence factor includes at least one of cag PAI, CagA, Peptidoglycan, or VacA Toxin.

With reference now to FIG. 4B, an illustration of a chemical reaction between electrodes and cancer precursors is depicted in accordance with an illustrative embodiment. In FIG. 4B, glassy carbon electrode (GCE) 406 is modified with nanocomposite 404 and screen printed carbon electrode (SPCE) 412 is modified with nanocomposite 410. Glassy carbon electrode (GCE) 406 and screen printed carbon electrode (SPCE) 412 are examples of electrodes in biosensor 206 in FIG. 2. Cancer precursors 402, 414, 416, 418, and cancer precursors 408, 420, 422, 424 are exemplary chemical structures of cancer precursors that can be detected using glassy carbon electrode (GCE) 406 and screen printed carbon electrode (SPCE) 412.

As a result, cancer precursors 402, 414, 416, and 418 react with nanocomposite 404 on glassy carbon electrode (GCE) 406 to produce products that can be detected and quantified. Similarly, cancer precursors 408, 420, 422, and 424 react with nanocomposite 410 on screen printed carbon electrode (SPCE) 412 to produce products that can be detected and quantified.

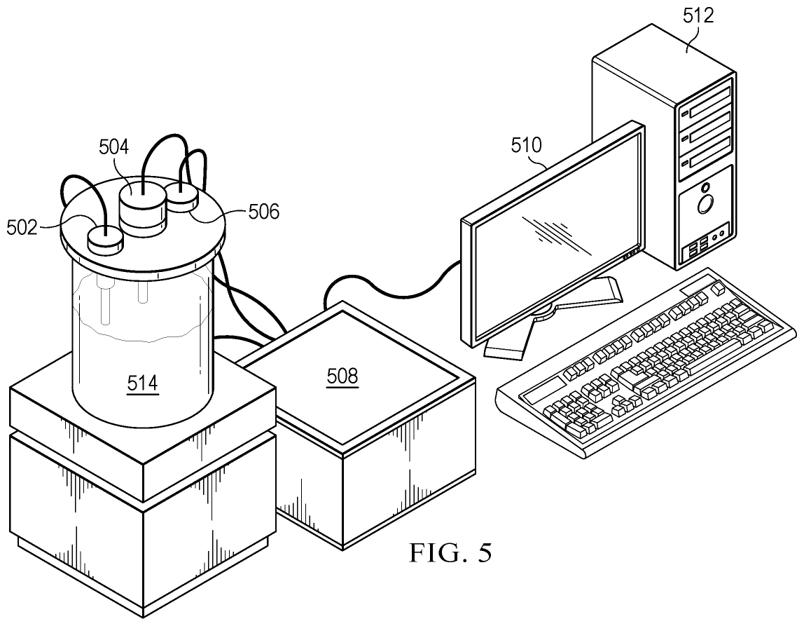

FIG. 5 illustrates a graphical representation of an alternative embodiment for a biosensor device in accordance with an illustrative embodiment. In FIG. 5, working electrode 506 is modified with a nanocomposite so that working electrode 506 can react with cancer precursors in sample 514 to generate a current to be processed and analyzed using an analytic tool 512.

In this illustrative example, working electrode 506 is the electrode where potential is controlled and where the current is measured, reference electrode 504 is used to measure the potential of working electrode 506, and counter electrode 502 is a conductor that completes the circuit. Controller 508 controls the potential of working electrode 506. Reaction between nanocomposites on working electrode 506 and cancer precursors in sample 514 generates a current that can be measured by controller 508. Subsequently, the measurement is sent to analytic tool 512 for further analysis. In this illustrative example, analytic tool 512 outputs a result that can be visualized on display 510.

In this illustrative example, working electrode 506 can be modified using a number of methods. For instance, an exemplary modification of electrodes first preparing a potassium phosphate buffered saline (K PBS) by using sodium phosphate monobasic monohydrate, sodium phosphate dibasic monohydrate and deionized water to create a 0.1M K PBS with a pH of 7. To evaluate which pH level worked most efficiently, pH of the sample 514 is made from a pH of 3 to a pH of 7 by addition of base or acid, respectively.

The working electrode 506 was constructed by following a three-step drop-casting modification method. In this example, working electrode 506 can be a glassy carbon electrode or a screen printed carbon electrode. Modification of glassy carbon electrodes begins by polishing the glassy carbon electrode with 0.05 μm alumina slurry solution for 30 min to remove any impurities. The glassy carbon electrode is then rinsed three times with deionized water and left to dry at room temperature. Subsequently, a volume of 3 μL of the nanomaterial suspension of copper cobalt (CuCo) in 5 mg/mL methanol is drop-casted on the electrode surface and left to air dry.

In this illustrative example, the nanomaterial suspension of copper cobalt (CuCo) includes a copper to cobalt ratio of from approximately 3:1 to approximately 1:3. For example, the copper to cobalt ratio for the nanomaterial suspension of copper cobalt (CuCo) can be 3:1, 2.5:1, 2:1, 1.5:1, 1.2:1, 1:1, 1:1.2, 1:1.5, 1:2, 1:2.5, or 1:3.

Once the electrode surface of the glassy carbon electrode is completely dry, 3 μL of a solution of 10 mg/mL N-(3-Dimethylaminopropyl)-N-ethyl carbodiimide hydrochloride (EDC·HCl) and 6 mg/mL N-hydroxy succinimide (NHS) is drop casted on the electrode surface of the glassy carbon electrode by incubating in the EDC-NHS solution for 30 min. The same process is applied when working electrode 506 is a screen printed carbon electrode, without the polishing step as described above.

Finally, working electrode 506 is modified with dilutions of N-nitrosodipropylamine (NDPA) of the following concentrations: 250 nM, 500 nM, 750 nM, 1 μM, 5 μM, 10 μM, 20 μM, 30 μM, 50 M, 70 μM, 85 M, 100 μM, 125 μM, 135 μM, and 150 μM. The dilutions are made from a 5 mM stock solution, which is used to create a 1 mM and 100 μM stock solution in the micromolar and nanomolar range were made, respectively. The 5 mM stock solution is made by using 6 μL of NDPA in aqueous and suspending it in 10 mL of K PBS. The resulted working electrode 506 can be an example of electrodes in biosensor 206 in FIG. 2.

It should be understood that using copper cobalt (CuCo) nanocomposite to modify electrodes is only one embodiment of this disclosure. The electrodes can also be modified using other nanomaterial such as magnesium nitrogen doped carbon, magnesium nitrogen and sulfur doped carbon, zirconium nitrogen doped carbon, zirconium nitrogen and sulfur doped carbon, cobalt nitrogen doped carbon, or cobalt nitrogen and sulfur doped carbon.

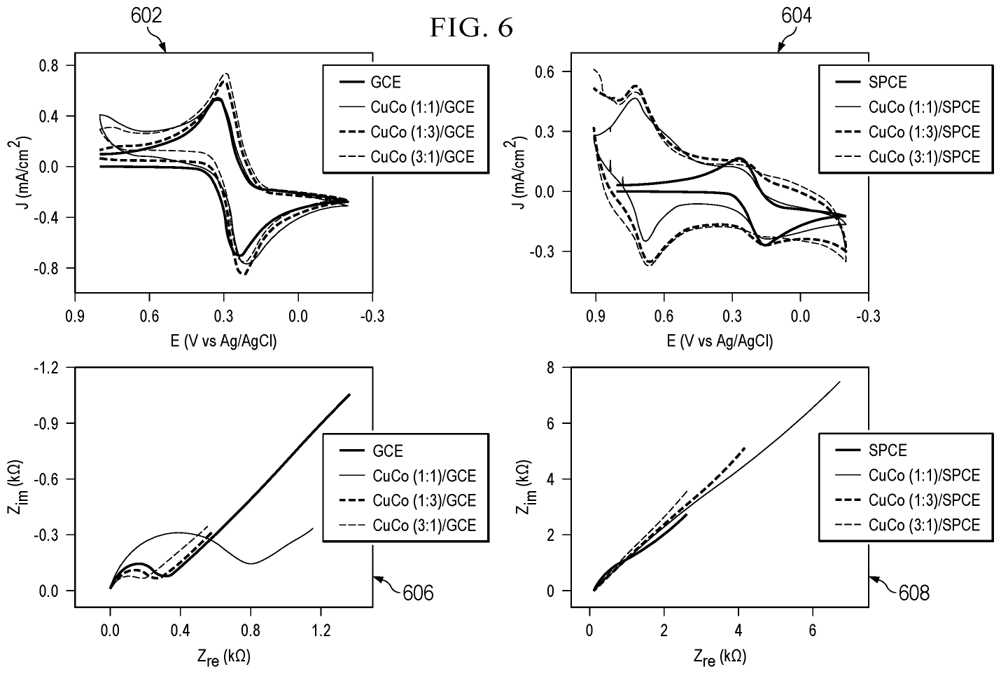

FIG. 6 illustrates an electrochemical characteristic of a copper cobalt modified glassy carbon electrode and a copper cobalt modified screen printed carbon electrode in accordance with an illustrative embodiment. CV (cyclic voltammetry) plot 602 and CV plot 604 present plots of bare, copper cobalt (1:1), copper cobalt (1:3), and copper cobalt (3:1) modified glassy carbon electrode and screen printed carbon electrode respectively, obtained from a 5 mM potassium ferricyanides (K₃[Fe(CN)₆]) solution. EIS (electrochemical impedance spectroscopy) plot 606 and EIS plot 608 present bare, copper cobalt (1:1), copper cobalt (1:3), and copper cobalt (3:1) modified glassy carbon electrode (GCE) and screen printed carbon electrode (SPCE) respectively, obtained from a 5 mM potassium ferricyanides solution.

In this illustrative example, copper cobalt (1:1) modified glassy carbon electrode and copper cobalt (1:1) modified screen printed carbon electrode are modified with a copper cobalt/carbon (Cu:Co/C) nanocomposite with a 1:1 copper to cobalt ratio. Similarly, copper cobalt (1:3) modified glassy carbon electrode and copper cobalt (1:3) modified screen printed carbon electrode are modified with a copper cobalt/carbon nanocomposite (Cu:Co/C) with a 1:3 copper to cobalt ratio, and copper cobalt (3:1) modified glassy carbon electrode and copper cobalt (3:1) modified screen printed carbon electrode are modified with a copper cobalt/carbon nanocomposite (Cu:Co/C) with a 3:1 copper to cobalt ratio.

In this example, the CV plot 602 and CV plot 604 show distinguishing features for the different Cu:Co/C nanocomposites when compared to a bare GCE and SPCE. The bare GCE shows redox peaks for [Fe(CN)₆]³⁻↔[Fe(CN)₆]⁴⁻ around 0.35 V and 0.5 V, while the bare SPCE shows redox peaks for [Fe(CN)₆]³⁻↔[Fe(CN)₆]⁴⁻ around 0.1 V and 0.2 V. On the other hand, after GCE and SPCE are modified with Cu:Co/C nanocomposites, the CV peak shape changed. Multiple redox peaks were observed for all three Cu:Co/C ratio in both GCE and SPCE. As depicted in CV plot 602 and CV plot 604, modified glassy carbon electrode with Cu:Co/C nanocomposite of ratio 1:1 (Cu:Co(1:1)/C_GCE) the redox pair for [Fc(CN)₆]^{3-/4-} is observed around 0.23 V and 0.5 V. The modified glassy carbon electrode with Cu:Co/C nanocomposite of ratio 1:3 (Cu:Co(1:3)/C_GCE) had the redox peaks around 0.22 V and 0.6 V, while the modified glassy carbon electrode with Cu:Co/C nanocomposite of ratio 3:1(Cu:Co(3:1)/C_GCE) showed the redox peaks around 0.2 V and 0.7 V. In addition, redox peaks for modified screen printed carbon electrode with Cu:Co/C nanocomposite of ratio 1:1 (Cu:Co(1:1)/C_SPCE), modified screen printed carbon electrode with Cu:Co/C nanocomposite of ratio 1:3 (Cu:Co(1:3)/C_SPCE), and modified screen printed carbon electrode with Cu:Co/C nanocomposite of ratio 3:1 (Cu:Co(3:1)/C_SPCE) are observed at 0.67V and 0.45 V, 0.65V and 0.55 V, and 0.65 and 0.47 V, respectively. The ΔEₚ and Jₚₐ/J_{pc} ratios for all three Cu:Co/C electrode systems are close to those for reversible redox systems. However, the Cu:Co(1:1)/C_GCE had the highest J values, indicating that the Cu:Co(1:1)/C nanocomposite demonstrated higher activity for the K₃[Fe(CN)₆] redox process.

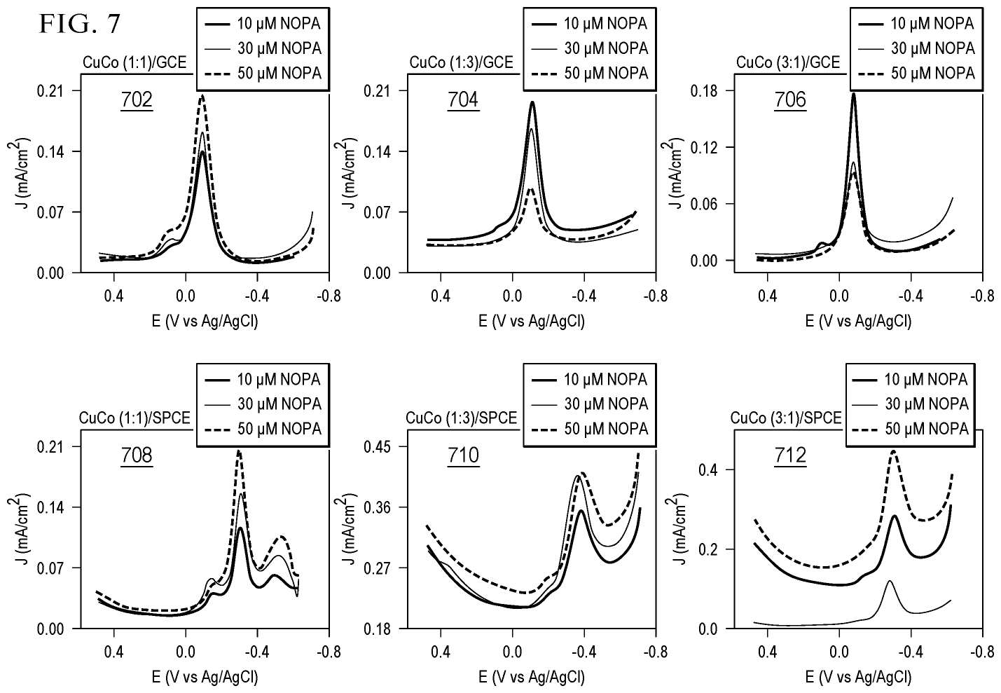

With reference now to FIG. 7, an illustration of electrochemical analysis of the modified electrodes with three CuCo/C nanocomposites ratios is depicted in accordance with an illustrative embodiment. In this example, the electrochemical analysis is evaluated using DPV by testing modified glassy carbon electrode and modified screen printed carbon electrode with different CuCo/C nanocomposites ratios using 10 μM, 30 M, and 50 μM NDPA, in PBS of pH 7.

Plot 702 shows that Cu:Co(1:1)/C_GCE has consistent high peak responses for each concentration of NDPA tested. In addition, plot 704 and plot 706 show that Cu:Co(1:3)/C_GCE and Cu:Co(3:1)/C_GCE do not yield stable results as concentration of NDPA increases. On the other hand, plot 708 and plot 710 show that Cu:Co(1:1)/C_SPCE and Cu:Co(1:3)/C_SPCE have consistent high peak responses for each concentration of NDPA tested, while plot 712 indicates that Cu:Co(3:1)/C_SPCE has unstable results due to an unproportional relationship between the peak and concentration variation.

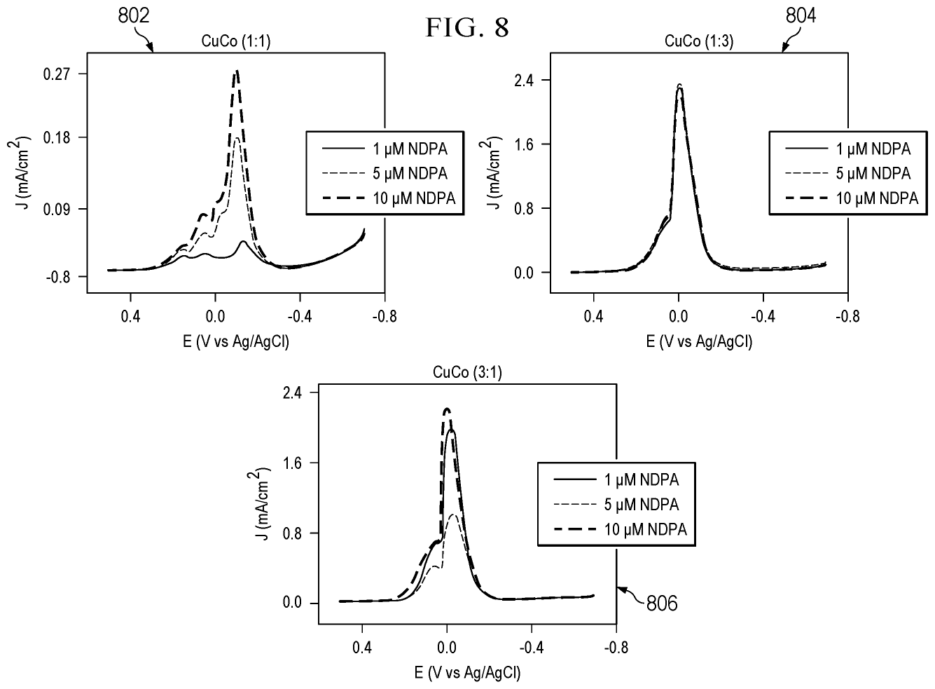

With reference now to FIG. 8, an illustration of electrochemical analysis for the modified electrodes with three CuCo/C nanocomposites ratios is depicted in accordance with an illustrative embodiment. In this example, the electrochemical analysis is evaluated using DPV by testing modified glassy carbon electrode with different CuCo/C nanocomposites ratios using 1 μM, 5 M, and 10 μM NDPA, in PBS of pH 5.

In FIG. 8, plot 802 shows that Cu:Co(1:1)/C_GCE with 10 μM NDPA produce the highest peak, and Cu:Co(1:1)/C_GCE with 5 μM NDPA produce a second highest peak while Cu:Co(1:1)/C_GCE with 1 μM NDPA produce the lowest peak. Such characteristics indicate that Cu:Co(1:1)/C_GCE has the best response since a constant proportional relationship between NDPA concentration variation and increase in peak response. On the other hand, plot 804 shows that Cu:Co(1:3)/C_GCE yield the same overlapping peak responses for all three concentrations, and plot 806 shows that Cu:Co(3:1)/C_GCE has an inconsistent increase in peak response with NDPA concentration variation.

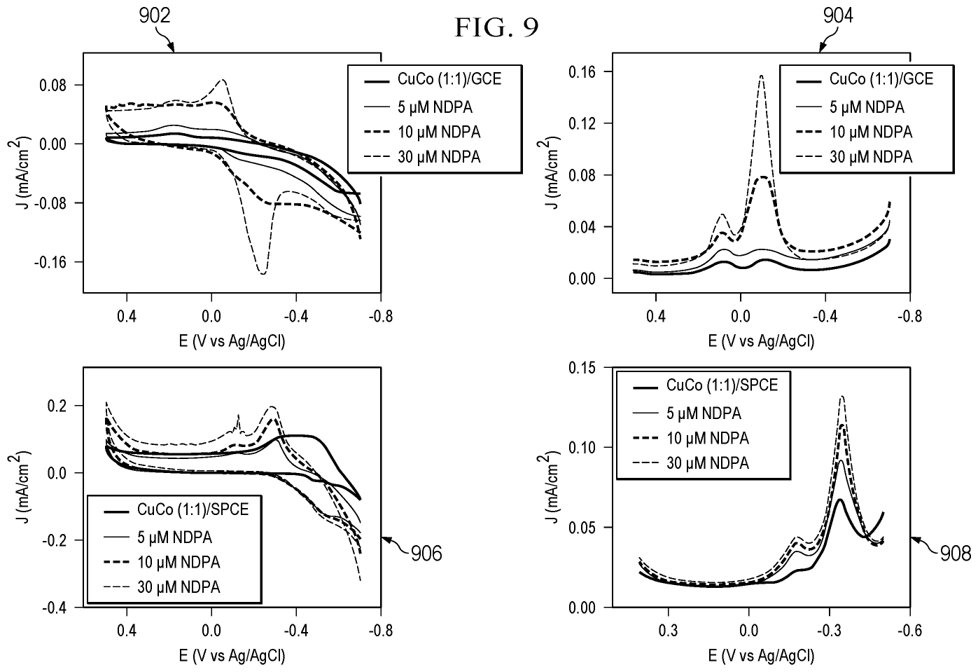

With reference now to FIG. 9, an illustration of electrochemical analysis for the modified electrodes with CuCo(1:1)/C nanocomposites ratios is depicted in accordance with an illustrative embodiment. In this example, the electrochemical analysis is evaluated using CV and DPV by testing both modified glassy carbon electrode and screen printed carbon electrode with CuCo(1:1)/C nanocomposites ratios using 5 μM, 10 μM, and 30 μM NDPA.

Plot 902 shows distinguishing features between the bare glassy carbon electrode modified with CuCo(1:1)/C nanocomposites ratio, and the addition of increasing concentrations of 5 μM, 10 μM, and 30 μM of NDPA. Plot 904 shows an obvious relationship between increasing concentrations of NDPA and an increasing peak response with glassy carbon electrode modified with CuCo(1:1)/C nanocomposites ratio.

Similarly, plot 906 shows distinguishing features between the bare screen printed carbon electrode modified with CuCo(1:1)/C nanocomposites ratio, and the addition of increasing concentrations of 5 μM, 10 μM, and 30 μM of NDPA. Plot 908 shows an obvious relationship between increasing concentrations of NDPA and an increasing peak response with screen printed carbon electrode modified with CuCo(1:1)/C nanocomposites ratio.

### EXAMPLES

Specific exemplary embodiments will now be further described by the following, nonlimiting examples, which will serve to illustrate in some detail various features. The following examples are included to facilitate an understanding of ways in which embodiments of the present disclosure may be practiced. However, it should be appreciated that many changes can be made in the exemplary embodiments which are disclosed while still obtaining like or similar result without departing from the scope of embodiments of the present disclosure. Accordingly, the examples should not be construed as limiting the scope of the present disclosure.

### Example 1

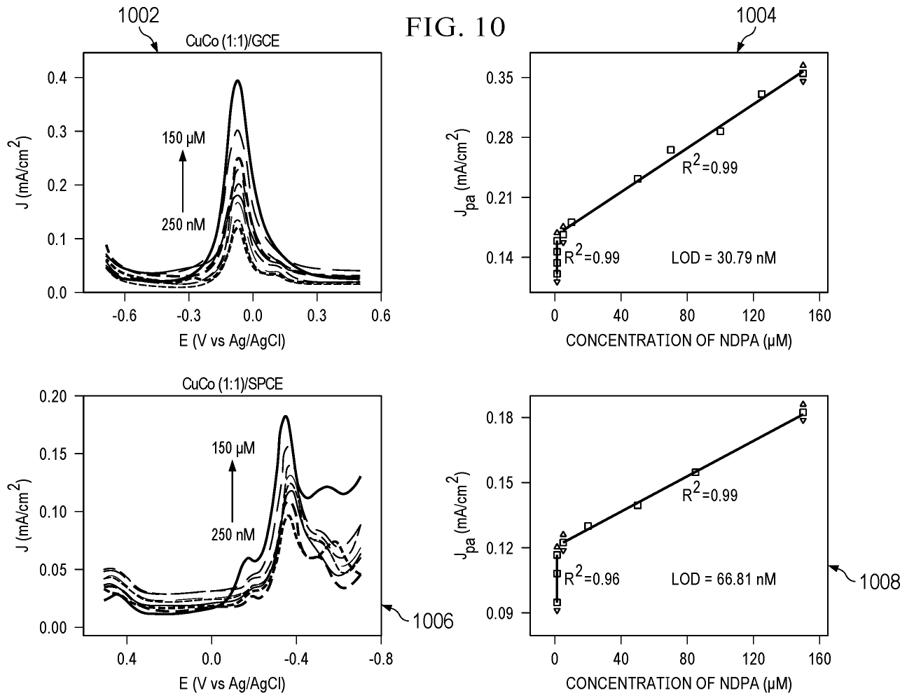

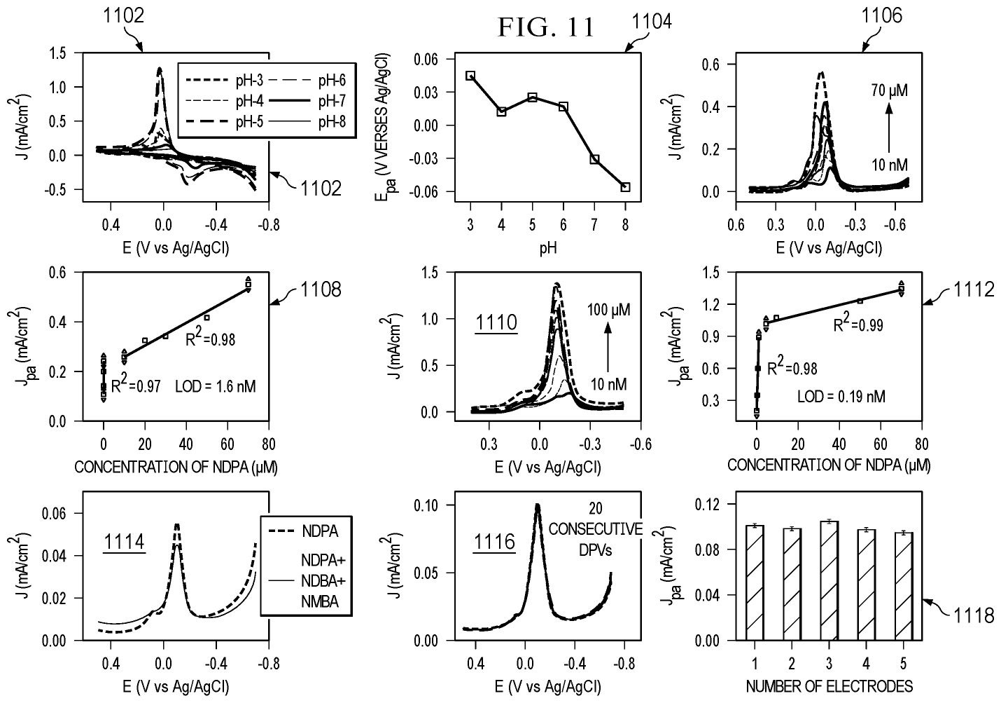

FIG. 10-11 illustrates evaluation of modified electrodes using differential pulse voltammetry (DPV) plot and calibration plot of electrodes modified with Cu:Co(1:1)/C nanocomposite for nitrosodipropylamine(NDPA) sensing in accordance with an illustrative embodiment.

In this example, plot 1002 shows DPV plots of GCE modified with Cu:Co(1:1)/C nanocomposite obtained for increasing concentration of NDPA from 250 nM to 150 μM and plot 1004 shows plot 1002's corresponding calibration plot of peak current versus NDPA concentration. In addition, plot 1006 shows DPV plots of SPCE modified with Cu:Co(1:1)/C nanocomposite obtained for increasing concentration of NDPA from 250 nM to 150 μM and plot 1008 shows plot 1006's corresponding calibration plot of peak current versus NDPA concentration.

In this illustrative example, plot 1002 and plot 1006 shows that a wide range of NDPA concentrations can be detected. In addition, plot 1002 shows a limit of detection of 30.79 nM and a R\hat{ }2 value of 0.99, and plot 1004 shows a limit of detection value of 66.81 nM and a R\hat{ }2 value of 0.99. The limit of detections and R\hat{ }2 values for both plot 1002 and plot 1004 indicate that both modified GCE and modified SPCE with a modification with Cu:Co(1:1)/C nanocomposite can detect NDPA at nanomolar scale with high sensitivity.

Plot 1102 illustrates variation of CV peak response of NDPA with change of solution with pH from 3 to 8. Plot 1104 shows plot 1102's corresponding calibration plot of peak potential (Eₚₐ) versus pH of solution. Plot 1102 and plot 1104 demonstrate that the highest CV peak response of NDPA with a solution of pH of 5. As a result, a solution with a pH of 5 is used to evaluate modified electrodes.

Plot 1106 illustrates the DPV plots obtained for increasing concentration of NDPA using glossary carbon electrode modified with CuCo(1:1)/C nanocomposites in phosphate-buffered saline (PBS) of pH 5. Plot 1108 shows plot 1106's corresponding calibration plot of anodic peak current (Jₚₐ) versus concentration of NDPA. A limit of detection is found at 1.6 nM with a R\hat{ }2 value of 0.97 and 0.98. Plot 1106 and plot 1108 show increase in sensitivity of glossary carbon electrode modified with CuCo(1:1)/C nanocomposites in a PBS of pH 5 to NDPA when compared the same system in a PBS with a pH of 7.

Plot 1110 illustrates the DPV plots obtained for different concentration of NDPA using screen printed carbon electrode modified with Cu:Co(1:1)/C nanocomposites in PBS of pH 5. Plot 1112 shows plot 1110's corresponding calibration plot of anodic peak current versus concentration of NDPA. Plot 1112 shows a limit of detection of 0.19 nM and R\hat{ }2 value of 0.98 and 0.99. Consequently indicating that screen printed carbon electrode modified with Cu:Co(1:1)/C nanocomposites in PBS of pH 5 is the most sensitive system.

Further, an interference study is conducted by introducing two other nitroso compounds with NDPA sensing. Plot 1114 illustrates the effect of N-nitrosodibutylamine (NDBA) and 4-nitro-4′-methyl benzylidene aniline (NMBA) on the DPV response of NDPA obtained by using glossary carbon electrode modified with CuCo(1:1)/C nanocomposites in neutral PBS. Plot 1114 indicates that NDPA still exhibits high peak current despite the interference from N-nitrosodibutylamine and 4-nitro-4′-methyl benzylidene aniline.

Plot 1116 illustrates consecutive DPV plots of increasing NDPA concentration using glossary carbon electrode modified with CuCo(1:1)/C nanocomposites. Plot 1116 shows consistent CV peak response of NDPA sensing with 20 consecutive experiments using the same glossary carbon electrode modified with CuCo(1:1)/C nanocomposites. In this example, plot 1116 indicates that modification of glossary carbon electrode remains robust over time.

Plot 1118 shows the bar plot of DPV peak current versus the number of glossary carbon electrode in PBS of pH 7. In this illustrative example, plot 1118 is used to evaluate the reproducibility of NDPA sensing using glossary carbon electrode modified with CuCo(1:1)/C nanocomposites. In this example, five glossary carbon electrodes are modified using CuCo(1:1)/C nanocomposites. Plot 1118 shows that CV peak responses of NDPA sensing for all five electrodes within the same range, indicating glossary carbon electrode modified with CuCo(1:1)/C nanocomposites will shows consistent results despite the number of times the sample is introduced.

### Example 2

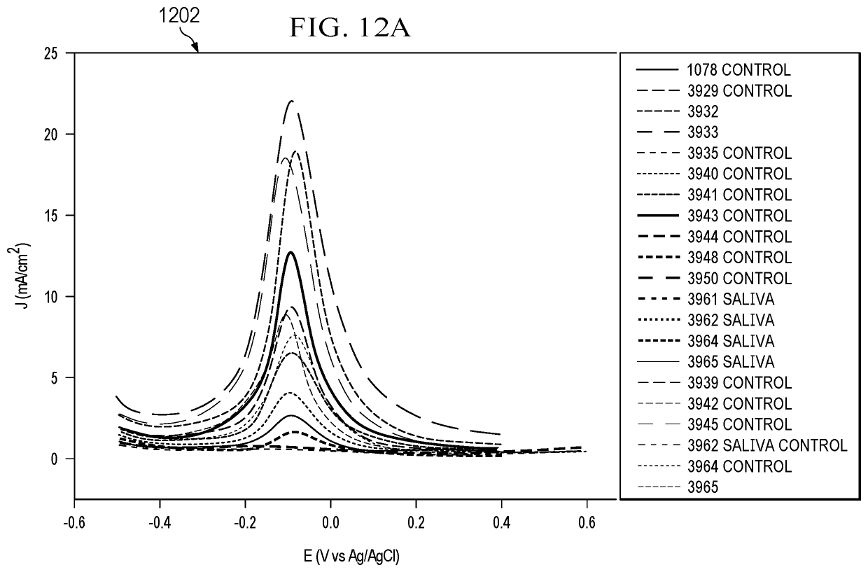

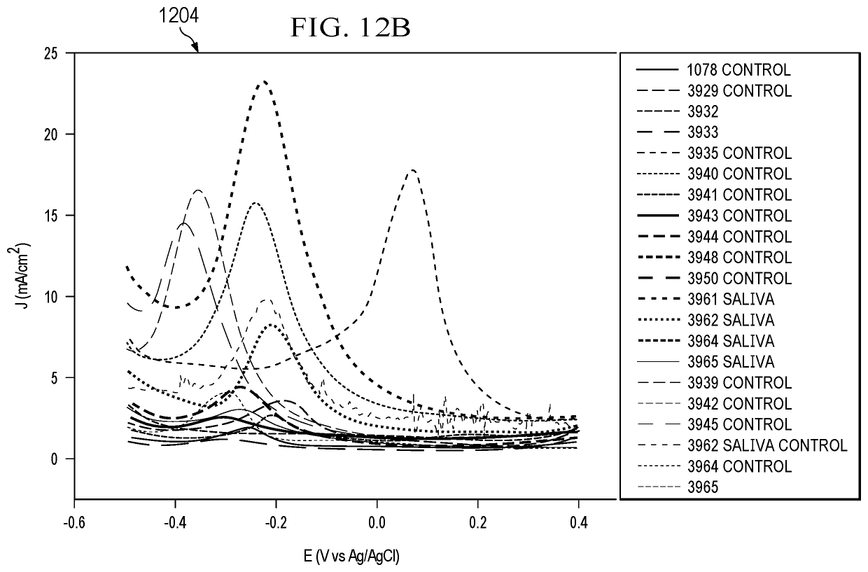

FIG. 12 illustrates an evaluation of modified electrodes using DPV plot to results of electrodes modified with Cu:Co(1:1)/C nanocomposite for NDPA sensing in real samples from patients in accordance with an illustrative embodiment. In this example, the real sample from patients includes 4 samples acquired from saliva and 17 from gastric juice. The electrodes are modified using the process described in FIG. 5, but instead of drop-casting varying NDPA concentrations, the patient samples were drop-casted as the third step in the modification process.

Plot 1202 shows results of glassy carbon electrode modified with Cu:Co(1:1)/C nanocomposite for NDPA sensing. Plot 1204 shows results of screen printed carbon electrode modified with Cu:Co(1:1)/C nanocomposite for NDPA sensing. In this illustrative example, modified glassy carbon electrode exhibits stable results, in which sample results demonstrate the highest peak responses compared to the controls. On the other hand, modified screen printed carbon electrode does not produce stable results since proportionally increased response cannot be observed as experimental samples were used.

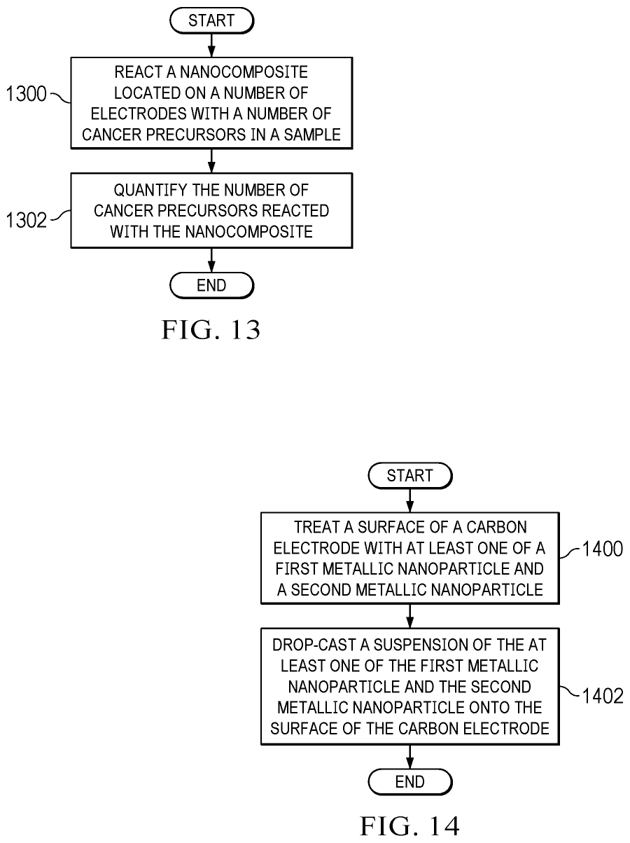

Turning next to FIG. 13, a flowchart of a process for detecting cancer precursors is depicted in accordance with an illustrative embodiment. The process in FIG. 13 can be an example of proposed approach 102 in FIG. 1. The process in FIG. 13 can be implemented in biosensor device 200 in FIG. 2.

The process begins by reacting a nanocomposite located on a number of electrodes with a number of cancer precursors in a sample (step 1300). The process quantifies the number of cancer precursors reacted with the nanocomposite (step 1302). The process terminates thereafter.

Turning next to FIG. 14, a flowchart of a process for manufacturing a sensor to detect cancer precursor is depicted in accordance with an illustrative embodiment. The process in FIG. 14 can be implemented to modify electrodes in biosensor 206 in FIG. 2.

The process begins by treating a surface of a carbon electrode with at least one of a first metallic nanoparticle and a second metallic nanoparticle (step 1400). The process then drop-casts a suspension of the at least one of the first metallic nanoparticle and the second metallic nanoparticle onto the surface of the carbon electrode (step 1402). The process terminates thereafter.

All of the methods disclosed and claimed herein can be made and executed without undue experimentation in light of the present disclosure. While the compositions and methods of the present disclosure have been described in terms of preferred embodiments, it will be apparent to those of skill in the art that variations may be applied to the methods and in the steps or in the sequence of steps of the method described herein without departing from the concept, spirit and scope of the present disclosure. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the present disclosure as defined by the appended claims.

What is claimed is:

1. An apparatus for detecting a cancer precursor, comprising:
a number of electrodes modified with a nanocomposite, wherein the nanocomposite reacts with a number of cancer precursors.

2. The apparatus of claim 1, wherein the number of electrodes comprises glass carbon electrodes.

3. The apparatus of claim 1, wherein the number of electrodes comprises screen printed carbon electrodes.

4. The apparatus of claim 1, wherein the number of cancer precursors comprises at least one of carcinogenic nitroso compounds or H. pylori virulence factor.

5. The apparatus of claim 4, wherein the carcinogenic nitroso compounds comprise at least one of N-nitrosomethylamine, N-nitroso-N-ethylurea, N-nitrosopirrolidone, N-nitrosonornicotine, N-nitrosopiperidine, N-nitrosomorpholine, N-nitrosodiethylamine, or N-nitrosodiethanolamine.

6. The apparatus of claim 4, wherein the H. pylori virulence factor comprises at least one of cag PAI, CagA, Peptidoglycan, or VacA Toxin.

7. The apparatus of claim 1, wherein the nanocomposite comprises a copper cobalt nanomaterial.

8. The apparatus of claim 7, wherein the copper cobalt nanomaterial comprises a copper to cobalt ratio of from approximately 1.5:1 to approximately 1:1.5.

9. The apparatus of claim 1, wherein the nanocomposite comprises at least one nanomaterial selected from a group comprising magnesium nitrogen doped carbon, magnesium nitrogen and sulfur doped carbon, zirconium nitrogen doped carbon, zirconium nitrogen and sulfur doped carbon, cobalt nitrogen doped carbon, or cobalt nitrogen and sulfur doped carbon.

10. A biosensor device for detecting cancer precursors in a sample, comprising:
a number of electrodes modified with a nanocomposite, wherein the nanocomposite reacts with a number of cancer precursors in the sample;
an analytic tool configured to quantify the number of cancer precursors reacted with the nanocomposite; and
a display to visualize amounts of the number of cancer precursors in the sample.

11. The biosensor device of claim 10, wherein the number of electrodes comprises glass carbon electrodes.

12. The biosensor device of claim 10, wherein the number of electrodes comprises screen printed carbon electrodes.

13. The biosensor device of claim 10, wherein the number of cancer precursors comprises at least one of carcinogenic nitroso compounds or H. pylori virulence factor.

14. The biosensor device of claim 13, wherein the carcinogenic nitroso compounds comprise at least one of N-nitrosomethylamine, N-nitroso-N-ethylurea, N-nitrosopirrolidone, N-nitrosonornicotine, N-nitrosopiperidine, N-nitrosomorpholine, N-nitrosodiethylamine, or N-nitrosodiethanolamine.

15. The biosensor device of claim 13, wherein the H. pylori virulence factor comprises at least one of cag PAI, CagA, Peptidoglycan, or VacA Toxin.

16. The biosensor device of claim 10, wherein the nanocomposite comprises a copper cobalt nanomaterial.

17. The biosensor device of claim 16, wherein the copper cobalt nanomaterial comprises a copper to cobalt ratio of from approximately 1.5:1 to approximately 1:1.5.

18. The biosensor device of claim 10, wherein the nanocomposite comprises at least one nanomaterial selected from a group comprising magnesium nitrogen doped carbon, magnesium nitrogen and sulfur doped carbon, zirconium nitrogen doped carbon, zirconium nitrogen and sulfur doped carbon, cobalt nitrogen doped carbon, or cobalt nitrogen and sulfur doped carbon.

19. A method of detecting cancer precursors, comprising:
reacting a nanocomposite located on a number of electrodes with a number of cancer precursors in a sample; and
quantifying the number of cancer precursors reacted with the nanocomposite.

20. The method of claim 19, wherein the number of electrodes comprises glass carbon electrodes.

21. The method of claim 19, wherein the number of electrodes comprises screen printed carbon electrodes.

22. The method of claim 19, wherein the number of cancer precursors comprises at least one of carcinogenic nitroso compounds or H. pylori virulence factor.

23. The method of claim 22, wherein the carcinogenic nitroso compounds comprise at least one of N-nitrosomethylamine, N-nitroso-N-ethylurea, N-nitrosopirrolidone, N-nitrosonornicotine, N-nitrosopiperidine, N-nitrosomorpholine, N-nitrosodiethylamine, or N-nitrosodiethanolamine.

24. The method of claim 22, wherein the H. pylori virulence factor comprises at least one of cag PAI, CagA, Peptidoglycan, or VacA Toxin.

25. The method of claim 19, wherein the nanocomposite comprises a copper cobalt nanomaterial.

26. The method of claim 25, wherein the copper cobalt nanomaterial comprises a copper to cobalt ratio of from approximately 1.5:1 to approximately 1:1.5.

27. The method of claim 19, wherein the nanocomposite comprises at least one nanomaterial selected from a group comprising magnesium nitrogen doped carbon, magnesium nitrogen and sulfur doped carbon, zirconium nitrogen doped carbon, zirconium nitrogen and sulfur doped carbon, cobalt nitrogen doped carbon, or cobalt nitrogen and sulfur doped carbon.

28. A composition of matter for detecting cancer precursors, comprising:
an electrode; and
a nanocomposite comprising:
a first metallic nanoparticle; and
at least one of a second metallic nanoparticle, or carbon nanomaterial.

29. The composition of matter of claim 28, wherein the nanocomposite comprises a copper cobalt nanomaterial.

30. The composition of matter of claim 29, wherein the copper cobalt nanomaterial comprises a copper to cobalt ratio of from approximately 1.5:1 to approximately 1:1.5.

31. The composition of matter of claim 28, wherein the first metallic nanoparticle is selected from a group comprising copper, zirconium, magnesium, or cobalt.

32. The composition of matter of claim 28, wherein the carbon nanomaterial is selected from a group comprising nitrogen doped carbon, or nitrogen and sulfur doped carbon.

33. A method of manufacturing a sensor to detect cancer precursors, comprising:
treating a surface of a carbon electrode with at least one of a first metallic nanoparticle and a second metallic nanoparticle.

34. The method of claim 33, wherein treating comprises drop-casting a suspension of the at least one of the first metallic nanoparticle and the second metallic nanoparticle onto the surface of the carbon electrode.

35. The method of claim 34, wherein the suspension has a copper to cobalt ratio of from approximately 1.5:1 to approximately 1:1.5.

36. The method of claim 33, wherein the carbon electrode comprises at least one nanomaterial selected from a group comprising magnesium nitrogen doped carbon, magnesium nitrogen and sulfur doped carbon, zirconium nitrogen doped carbon, zirconium nitrogen and sulfur doped carbon, cobalt nitrogen doped carbon, or cobalt nitrogen and sulfur doped carbon.
